(19) United States
(12) Patent Application Publication
(10) Pub. No.: US 2026/0322016 A1
(43) Pub. Date: Oct. 15, 2026

(54) HIGH-SPEED ELECTRICAL CONNECTOR WITH MATING-DIRECTION FLOATING CAPABILITY

(71) Applicant: Amphenol Aorora Technology (Huizhou) Co., Ltd., Huizhou (CN)

(72) Inventors: Qi Han, Huizhou (CN); Xiaohong Zhu, Huizhou (CN)

(73) Assignee: Amphenol Aorora Technology (Huizhou) Co., Ltd., Huizhou (CN)

(21) Appl. No.: 19/646,814

(22) Filed: Apr. 14, 2026

(30) Foreign Application Priority Data
Apr. 15, 2025 (CN) 202510475810.0

(51) Int. Cl. H01R 12/91; H01R 12/70; H01R 13/24; H01R 13/506

(52) U.S. Cl. CPC H01R 12/91; H01R 12/7023; H01R 12/707; H01R 12/7082; H01R 13/24; H01R 13/506

(57) ABSTRACT

High-speed electrical connectors with mating-direction floating capability. A receptacle connector includes an inner housing elastically connected to an outer housing, thereby movable with respect to the outer housing in a mating direction of the connector. The outer housing includes a base and a chamber. The inner housing is disposed in the chamber and protrudes above the chamber in the mating direction. The inner housing includes an arm elastically connected to the base and movable between a locking member and the base. The inner housing is movable by a plug connector mated with the receptacle connector such that boards connected to the receptacle connector and the plug connector are separated by a predetermined distance. The techniques enable connectors capable of satisfying PCIe Gen 5.0's signal transmission requirements at 32 Gbps, while satisfying reliability requirements of industry standards (e.g., USCAR-2-V2) with floating terminals capable of moving to accommodate manufacturing and/or assembling variation.

### CROSS-REFERENCE TO RELATED APPLICATIONS

This application claims priority to and the benefit of Chinese Patent Application No. 202510475810.0, filed on Apr. 15, 2025. The contents of this application are incorporated herein by reference in their entirety.

### TECHNICAL FIELD

This application relates generally to interconnection systems, such as those including electrical connectors, used to interconnect electronic assemblies.

### BACKGROUND

Electrical connectors are used in many electronic systems. It is generally easier and more cost effective to manufacture a system as separate electronic assemblies, which may be joined with electrical connectors. Electrical connectors may be used for interconnecting electronic assemblies so that the electronic assemblies may operate together as part of a system. Connectors, for example, may be mounted on printed circuit boards within two assemblies that are connected by mating the connectors.

Connectors may be implemented according to standards that are available to multiple connector suppliers. Connectors meeting the standard made by one connector manufacturer may mate with connectors that similarly meet the standard made by another connector manufacturer. In this way, subassemblies of an electronic device may be produced by different suppliers at different times and in different places, but may be easily integrated into a larger electronic system by mating connectors. An example of such a standard is Peripheral Component Interconnect Express (PCIe), and many servers use connectors according to this standard.

### SUMMARY

Aspects of the present disclosure relate to high-speed electrical connectors with mating-direction floating capability.

Some embodiments relate to a receptacle connector. The receptacle connector may comprise an outer housing comprising a base and a chamber above the base; an inner housing disposed in the chamber and protruding above the chamber in a mating direction, the inner housing comprising a pair of arms elastically connected to the base of the outer housing such that the inner housing is movable with respect to the outer housing in the mating direction; and a plurality of terminals elastically connected to both the inner housing and the outer housing such that contact portions of the plurality of terminals move with the inner housing in the mating direction.

Optionally, the inner housing comprises a pair of end walls separated in a horizontal direction perpendicular to the mating direction, a pair of side walls separated in a longitudinal direction perpendicular to both the mating direction and the horizontal direction, and a slot bounded by the pair of end walls and the pair of side walls; and the pair of arms of the inner housing extend from lower ends of respective end walls of the pair of end walls in both the horizontal direction and mating direction.

Optionally, the slot is elongated in the horizontal direction.

Optionally, the receptacle connector comprises a pair of resilient members; wherein each of the pair of arms of the inner housing comprises a space receiving a respective resilient member of the pair of resilient members.

Optionally, each of the pair of resilient members comprises a first portion fixedly disposed in the space of a respective arm of the pair of arms of the inner housing, and a second portion comprising a beam movable with respect to the first portion.

Optionally, the base of the outer housing comprises a gap; and the beam extends into the gap of the base of the outer housing.

Optionally, each of the plurality of terminals comprises a first segment partially disposed in the inner housing, a second segment at least partially disposed in the chamber of the outer housing, and a third segment at least partially disposed in the outer housing; and for each of the plurality of terminals, the first segment, second segment, and third segment are connected by respective bent portions.

Optionally, the inner housing comprises a tongue disposed in the slot; and the first segment of each of the plurality of terminals comprises a contact portion lines along the tongue and curves into the slot.

Optionally, the receptacle connector comprises a pair of locking members disposed on the base and configured to restrain movements of the pair of arms in the mating direction.

Optionally, the pair of locking members are configured to mount to a board to which the receptacle connector is disposed on.

Some embodiments relate to a floating connector assembly. The floating connector assembly may comprise the receptacle connector; and a plug connector configured to mate with the receptacle connector and capable of driving the inner housing to move in the mating direction such that boards connected to the receptacle connector and the plug connector are separated by a predetermined distance.

Some embodiments relate to a method of operating a receptacle connector comprising an outer housing having a chamber, and an inner housing disposed in the chamber and protruding above the chamber, the inner housing having a slot. The method may comprise receiving a plug connector in the slot of the inner housing; and moving the inner housing with respect to the outer housing by the plug connector such that boards connected to the receptacle connector and the plug connector are separated by a predetermined distance.

Optionally, moving the inner housing with respect to the outer housing comprises expanding or compressing a resilient member fixedly attached to an arm of the inner housing.

Optionally, moving the inner housing with respect to the outer housing comprises restraining movements of the arm of the inner housing with a locking member.

Some embodiments relate to a plug connector. The plug connector may comprise an outer housing comprising a chamber; and a pair of subassemblies at least partially separated by a slot therebetween, each subassembly comprising an inner housing member disposed in the chamber of the outer housing, and a plurality of terminals held by the inner housing member, each of the plurality of terminals comprising a contact portion accessible through the slot, a contact tail extending out of the outer housing, and a main body between the contact portion and the contact tail.

Optionally, for each of the pair of subassemblies, the inner housing member comprises a side wall, and a pair of end wall portions on opposite ends of the side wall so as to bound half of the slot together with the side wall.

Optionally, the side wall comprises a plurality of mounting channel portions; and the contact tails of the plurality of terminals of the subassembly are partially disposed in respective mounting channel portions of the plurality of mounting channel portions.

Optionally, for each of the plurality of terminals, the main body elongates in a mating direction, and has a constant thickness in a longitudinal direction perpendicular to the mating direction.

Optionally, the main body comprises a fixing portion extending in a horizontal direction perpendicular to both the mating direction and the longitudinal direction.

Optionally, the side wall comprises a plurality of channel portions in a hollow region; and the fixing portions are disposed corresponding to the plurality of channel portions.

Some embodiments relate to a plug connector. The plug connector may comprise a plug inner housing comprising a pair of plug end walls separated in a horizontal direction and a pair of plug side walls separated in a longitudinal direction, the plug end walls and the plug side walls together surrounding a plug slot, each plug side wall comprising a plurality of mounting channel portions; a plug outer housing comprising a plug chamber, the plug inner housing disposed in the plug chamber; and a plurality of first terminals insert molded in the plug inner housing, each first terminal comprising a main body and a first contact portion and a contact tail at opposite ends of the main body, the contact tail bending from a lower end of the main body in a direction away from the plug slot, and the contact tail embedded in the mounting channel portion, wherein the main body may be a smooth linear structure in a mating direction.

Optionally, for each of the plurality of first terminals, the main body extends along the mating direction and has a constant width in the horizontal direction and a constant thickness in the longitudinal direction.

Optionally, for each of the plurality of first terminals, the main body extends along the mating direction and comprises a fixing portion that is thickened in the horizontal direction; the plug side wall comprises a plurality of channel portions in a hollow region; and the fixing portions are disposed corresponding to the channel portions.

Optionally, the fixing portion comprises a first fixing block and a second fixing block; in the horizontal direction, a width of the first fixing block is the same as a width of the second fixing block; in the longitudinal direction, a thickness of the first fixing block is the same as a thickness of the second fixing block; and in the mating direction, a height of the first fixing block is the same as or different from a height of the second fixing block, and the first fixing block and the second fixing block are alternately disposed on the main body.

Optionally, neither the first fixing block nor the second fixing block comprises a barb or hook extending in the horizontal direction.

Optionally, the plug inner housing comprises a pair of inner housing members assembled together; each inner housing member comprises one of the pair of plug side walls; the main bodies are insert molded in the plug side wall, whereby the first terminal and the inner housing member form an integral structure.

Some embodiments relate to a receptacle connector configured to mate with the plug connector. The receptacle connector may comprise a receptacle inner housing comprising a pair of receptacle end walls separated in the horizontal direction, a pair of receptacle side walls separated in the longitudinal direction, and a pair of arms, the receptacle end walls and the receptacle side walls together surrounding a receptacle slot, the arms extending from lower ends of the receptacle end walls in both the horizontal direction and mating direction; a receptacle outer housing comprising a base and a receptacle chamber above the base, the receptacle inner housing disposed in the receptacle chamber, and the arms elastically connected to the base; and a plurality of second terminals, each an integrally shaped elastic metal member and connected to both the receptacle inner housing and the receptacle outer housing.

Optionally, each second terminal comprises a first segment, a second segment, and a third segment, the first segment partially disposed in the receptacle inner housing and partially disposed in the receptacle chamber, the second segment at least partially disposed in the receptacle chamber, the third segment at least partially disposed in the receptacle outer housing.

Optionally, for each second terminal, the first segment comprises a second contact portion; the second contact portion first bends in a direction away from the receptacle slot and then bends in a direction approaching the receptacle slot; and the second contact portion is configured to make contact with a respective first contact portion.

Optionally, the receptacle connector comprises a U-shaped resilient member, the resilient member comprising a first portion and a second portion integrally shaped, the first portion fixed to a bottom of the arm, and the second portion abutting against the base.

Some embodiments relate to a floating connector assembly comprising a plug connector described herein and a receptacle connector described herein, wherein the plug connector is mated with the receptacle connector; and the plug connector is capable of driving the receptacle inner housing to move downward relative to the receptacle outer housing in the mating direction.

These techniques may be used alone or in any suitable combination. The foregoing summaries are provided by way of illustration and are not intended to be limiting.

### BRIEF DESCRIPTION OF THE DRAWINGS

The accompanying drawings are not intended to be drawn to scale. In the drawings, identical or nearly identical components that are illustrated in various figures may be represented by a like numeral. For purposes of clarity, not every component may be labeled in every drawing. In the drawings:

FIG. 1 is a perspective view of a plug connector, according to some embodiments.

FIG. 2 is an exploded perspective view of the plug connector of FIG. 1.

FIG. 3 is a perspective view of a first terminal of the plug connector of FIG. 1, with an enlarged view of a portion of a main body having a fixing portion.

FIG. 4 is a perspective view of a plug inner housing and the first terminals of the plug connector of FIG. 1.

FIG. 5 is a cross-sectional view of the plug connector of FIG. 1, taken along a line marked “A-A” in FIG. 1.

FIG. 6 is an enlarged view of an area of the plug connector of FIG. 1 within a circle marked “B” in FIG. 2.

FIG. 7 is a perspective view of a receptacle connector, according to some embodiments.

FIG. 8 is an exploded perspective view of the receptacle connector of FIG. 2.

FIG. 9 is a cross-sectional view of the receptacle connector of FIG. 7, taken along a line marked “C-C” in FIG. 7 and including an enlarged view of a second terminal.

FIG. 10 is a cross-sectional view of the receptacle connector of FIG. 7, taken along a line marked “D-D” in FIG. 7 and including an enlarged view of a region within a dashed box.

FIG. 11 is a perspective view of a floating connector assembly comprising the plug connector of FIG. 1 and the receptacle connector of FIG. 7, according to some embodiments.

FIG. 12 is a cross-sectional view of the connector assembly of FIG. 11, taken along a line marked “E-E” in FIG. 11.

FIG. 13 is a cross-sectional view of the connector assembly of FIG. 11, taken along a line marked “F-F” in FIG. 11.

List of Reference Signs: 100 plug connector; 200 receptacle connector; 300 floating connector assembly; 1 plug inner housing, 11 plug end wall, 12 plug side wall, 121 mounting channel portion, 122 channel portion in a hollow region, 13 plug slot, 14 inner housing member; 2 plug outer housing, 21 plug chamber, 22 board lock, 23 board lock receiver; 3 first terminal, 31 main body, 310 fixing portion, 311 first fixing block, 312 second fixing block, 32 first contact portion, 33 contact tail; 4 receptacle inner housing, 41 receptacle end wall, 42 receptacle side wall, 43 arm, 431 space, 44 receptacle slot, 441 tongue, 45 longitudinal gap; 5 receptacle outer housing, 51 base, 511 vertical gap, 52 receptacle chamber, 53 locking member; 6 second terminal, 61 first segment, 611 second contact portion, 62 second segment, 63 third segment, 64 bending angle; 7 resilient member, 71 first portion, 72 second portion, 721 beam; X horizontal direction, Y longitudinal direction, Z mating (height) direction.

### DETAILED DESCRIPTION

The inventors have recognized and appreciated techniques for making electrical connectors that support high-speed data transmission rates (e.g. 32 Gbps or above) and high density interconnections as are conventionally used in computers and servers. These connectors may, in some examples, make connections between parallel boards that are separated by relatively large distances, such as 25 mm or more. Such connectors may nonetheless be suitable for use in a harsh environments, such as those encountered in automotive and robotics applications. Some such techniques may provide a mating-direction floating capability in connectors that concurrently satisfy demanding data transmission rate, density, and/or stack height requirements.

The inventors have recognized and appreciated that, as the spacing between circuit boards increases, relative displacement between the boards may occur under dynamic conditions (e.g., sudden changes in motion), resulting in deformation at connector mating ends. The extent of such deformation tends to increase with greater board spacing, which can reduce transmission stability and potentially damage the connector. Additionally, increased board spacing exacerbates installation misalignment, making connectors more susceptible to localized poor contact between terminals during static assembly. Conventional solutions for large board spacing often have a connection interface implemented using two wire-to-board connectors and a data cable, which may compromise transmission efficiency and limit data transmission performance. The inventors have further recognized and appreciated that conventional floating board-to-board connectors often increase the terminal's contact lengths to provide tolerance and maintain contact stability, which may be insufficient to meet practical requirements as board spacing continues to increase. Furthermore, sliding and wiping between terminals may introduce interference, signal loss, and wear of terminal plating, which may compromise transmission efficiency and limit data transmission performance. Techniques described herein may enable connectors capable of satisfying PCIe Gen 5.0's signal transmission requirements at 32 Gbps, while satisfying reliability requirements of industry standards (e.g., USCAR-2-V2) with floating terminals capable of moving to accommodate manufacturing and/or assembling variation. Techniques described herein may also enable a connector system capable of reliably operating in a range of heights. For example, a plug connector may be configured for inserting into a receptacle connector in a mating direction by a distance that can vary in a range of 0 to 1.0 mm. For example, if the nominal mating height (fully mated) of a system is 32.0 mm, the system can operate reliably in a mating height range of 31.0 mm to 33.0 mm.

According to aspects of the present disclosure, each terminal of a plug connector may include a main body having a smooth linear structure and insert molded into a plug inner housing. Such a configuration may improve manufacturing feasibility. Such a configuration may reduce signal transmission loss while maintaining high stability, thereby enabling high-frequency and high-speed inter-board data transmission.

In some embodiments, the terminals of the plug connector may not require a dedicated mold. During mass production, the length of the raw material may be selected based on the desired board spacings. While maintaining a secure connection between the terminals and the plug inner housing, the utilization of the terminal production line may be improved, and the processing complexity and production cost for plug connectors of various lengths may be reduced. Such a configuration may enable a range of mated heights for the system including the plug connector, for example, between 32.0 mm and 48.0 mm.

According to aspects of the present disclosure, a receptacle connector may include receptacle inner housing and receptacle outer housing arranged independently of one another. The receptacle inner housing may include arms elastically connected to a base of the receptacle outer housing. Each terminal of the receptacle connector may be elastically disposed between the receptacle inner housing and the receptacle outer housing. Such a configuration may maintain effective and stable electrical connection of the system comprising the receptacle connector, even when a relatively large displacement or offset occurs between the receptacle inner housing and the receptacle outer housing in the mating direction.

According to aspects of the present disclosure, in a floating connector assembly, after a plug connector is mated with a receptacle connector, the receptacle inner housing and the receptacle outer housing may form a floating connection. As a result, even if there is a relatively large positional deviation during static mating between the plug connector and the receptacle connector, or if relative displacement occurs between circuit boards during operation, the plug connector may maintain a relatively stable connection state with the receptacle inner housing. The plug connector may further drive the receptacle inner housing to move relative to the receptacle outer housing in a mating direction. Consequently, the connection position between the plug terminals and the receptacle terminals may remain substantially unchanged, thereby reducing poor contact or unstable transmission and improving data transmission reliability and service life.

For ease of reference in understanding the drawings, a three-axis coordinate system may be shown in the drawings. The X-axis may correspond to a horizontal direction, the Y-axis may correspond to the longitudinal direction, and the Z-axis may correspond to a mating (height) direction.

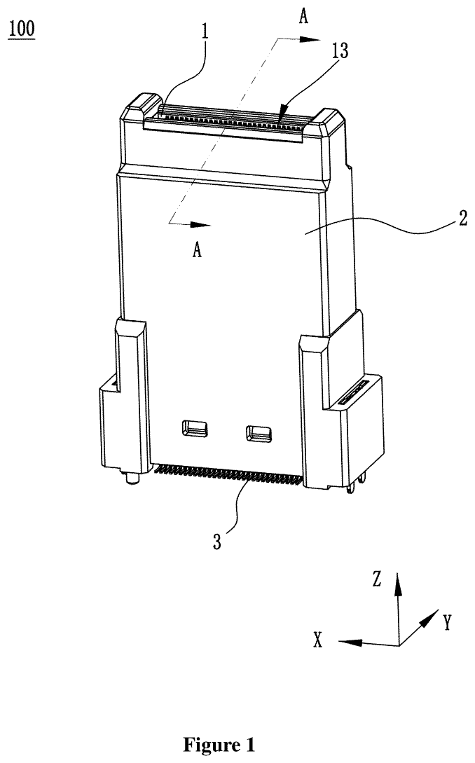

Referring to FIGS. 1-3, a plug connector 100 may comprise a plug inner housing 1, a plug outer housing 2, and first terminals 3. The plug inner housing 1 is configured to fix the first terminals 3, and specifically comprises a pair of plug end walls 11 oppositely disposed in the horizontal direction X and a pair of plug side walls 12 disposed in the longitudinal direction Y. The plug end walls 11 and the plug side walls 12 together surround to form a plug slot 13. The plug slot 13 is configured to provide installation conditions when the plug connector 100 is electrically connected to the receptacle connector plugging therewith. The plug outer housing 2 is configured to fix the plug inner housing 1 and the first terminals 3, and forms a fixed structure with a circuit board at one end, providing the main load-bearing capacity of the plug connector 100. The plug outer housing 2 comprises a plug chamber 21, and the plug inner housing 1 is disposed in the plug chamber 21.

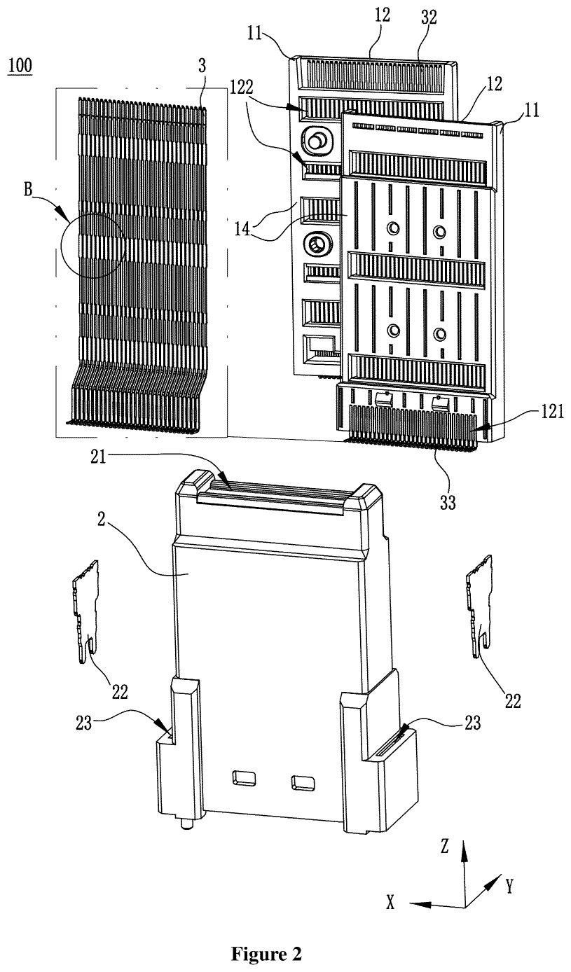

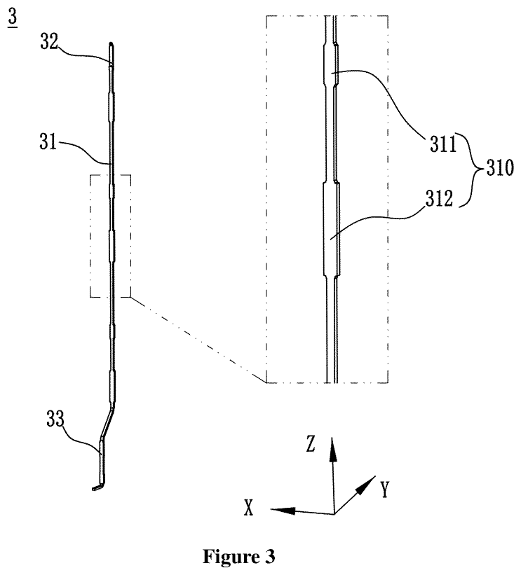

The first terminals 3 is disposed in the plug inner housing 1 by an insert molding process. Referring to FIG. 3 in combination with FIGS. 1-2, each first terminal 3 comprises a main body 31 and a first contact portion 32 and a contact tail 33 provided at two ends of the main body 31. The first contact portion 32 is disposed on an inner side of the plug slot 13. Electrical connection between the plug connector 100 and its receptacle connector is achieved by plugging in the plug slot 13.

The contact tail 33 is formed by bending from a lower end of the main body 31 in a direction away from the plug slot 13, and extends out of the plug outer housing 2. The plug side wall 12 of the plug inner housing 1 comprises a mounting channel portion 121, and the contact tail 33 of the first terminal 3 is partially disposed in a respective in the mounting channel portion 121. The contact tail 33 is bent and partially disposed in the mounting channel portion 121, so that the contact tail 33 can be exposed outside the plug outer housing 2 while ensuring a firm connection with the plug inner housing 1, thereby allowing soldering to the electrical contacts of the circuit board at one end of the plug connector 100.

In the illustrated embodiment, the main body 31 is a smooth linear structure in the mating direction Z. Preferably, the main body 31 is a smooth straight-line structure in the mating direction Z. In some embodiments, the main body 31 can also be a smooth curved structure. The specific linear type is selected according to design requirements. The main body 31 using a straight-line structure has advantages in traditional high-frequency and high-speed data transmission, such as stable transmission, low probability of data loss and errors, etc.

The smooth straight-line structure may enable multiple first terminals 3 in the same row to be blanked and cut from flat raw materials during production, and produced and shaped together, greatly reducing the production process difficulty of the first terminals 3 and significantly improving production efficiency. Furthermore, if it is necessary to produce plug connectors 100 of the same type but different lengths, only the length of the raw material of the first terminals 3 and the injection mold of the plug inner housing 1 need to be changed, improving manufacturing feasibility. Moreover, the investment cost and the production cost for producing plug connectors 100 of different lengths later are reduced, and the production line changeover time for plug connectors 100 of different lengths is also reduced.

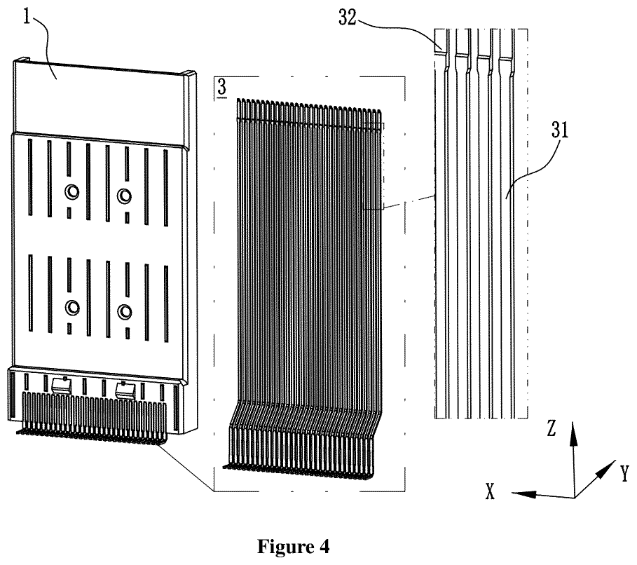

In some embodiments, as shown in FIG. 4, the main body 31 elongates in the mating direction Z and has a constant thickness in the longitudinal direction Y perpendicular to the mating direction Z. The main body 31 may also have a constant width in the horizontal direction X. For example, at any position perpendicular to the mating direction Z, the cross-section of the main body 31 in the plane of the horizontal direction X and the longitudinal direction Y is the same, a uniform structure. By being insert molded into the plug inner housing 1, each first terminal 3 has the periphery of the main body 31 wrapped by the material of the plug inner housing 1. This ensures that when first terminals 3 transmit data, they do not interfere with each other, and the data transmission process is stable and controllable. The first terminals 3 described herein can be disposed according to the minimum spacing between terminals, thereby improving the terminal density and data transmission capability of the plug connector. This meets the higher frequency and higher speed data transmission requirements for board-to-board connectors.

In existing plug products of floating connectors, terminals and housings are fit by assembling. With the assembling method, the terminal is designed to have a fixing structure with projections, but this causes significant signal transmission loss. The illustrated example, by using a first terminal with a main body of a uniform structure, improves manufacturing feasibility on one hand, and reduces signal transmission loss on the other hand.

In some embodiments, to meet requirements such as detection and weight reduction, the main body 31 extends along the mating direction Z and comprises a fixing portion 310 that is thickened in the horizontal direction X. Correspondingly, the plug side wall 12 comprises a channel portion 122 in a hollow region, and the fixing portion 310 is disposed corresponding to the channel portion 122 in a hollow region.

As shown in FIGS. 1-3, on the plug inner housing, the channel portions 122 are often arranged at intervals, which can be used during the production process to detect whether each section of the first terminal 3 in the mating direction Z meets relevant electrical requirements. When the first terminal 3 and the plug inner housing 1 are insert molded, the provision of the channel portions 122 also facilitates demolding of the plug inner housing 1 and reduces the weight of the plug inner housing 1. Simultaneously, considering that the electrical performance of metal terminals varies across different environmental media, and to ensure no problems such as data transmission distortion when crossing different environmental media, the main body 31 comprises a thickened fixing portion 310 correspondingly at the position of the channel portion 122 in a hollow region to solve the above problem.

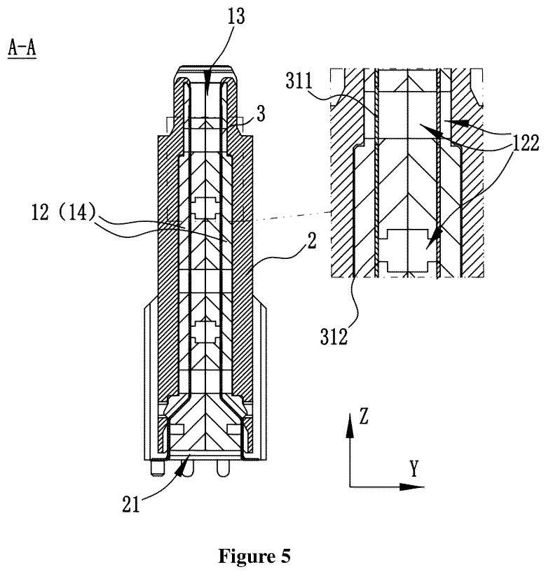

Further, the fixing portion 310 comprises a first fixing block 311 and a second fixing block 312. In the horizontal direction X, a width of the first fixing block 311 is the same as a width of the second fixing block 312. In the longitudinal direction Y, a thickness of the first fixing block 311 is the same as a thickness of the second fixing block 312. In the mating direction Z, a height of the first fixing block 311 is the same as or different from a height of the second fixing block 312, and the first fixing block 311 and the second fixing block 312 are alternately disposed on the main body 31. The first fixing block 311 and the second fixing block 312 are disposed with respect to different situations of the channel portion 122 in a hollow region. In the illustrated example, the height of the first fixing block 311 is different from the height of the second fixing block 312, and the height of the first fixing block 311 is greater than the height of the second fixing block 312. Referring to FIG. 5 in combination with FIGS. 1-3, when the channel portion 122 in a hollow region penetrates the plug inner housing 1, there is an improved data transmission effect if the first fixing block 311 is disposed at this channel portion 122 in a hollow region. When the channel portion 122 in a hollow region is only provided on one side of the plug slot 13, the second fixing block 312 with a smaller height can have the corresponding effect.

Alternately arranging the first fixing block 311 and the second fixing block 312 helps standardize the main body 31, adapting to the needs of connectors of the same series but different lengths.

Neither the first fixing block 311 nor the second fixing block 312 may comprise a barb or hook extending in the horizontal direction X. Conventional connectors often have terminals with protruding structures, such as serrated or tapered protrusions, to facilitate retention and accurate positioning after insertion into a housing. In the present disclosure, by employing an insert molding process, the first terminals 3 are securely coupled to the plug inner housing 1 without the need for such protruding structures. The absence of protruding structures allows the center-to-center spacing between adjacent terminals to be reduced, thereby increasing terminal density of the plug connector 100 and enhancing overall data transmission capability. Additionally, eliminating such protruding structures reduces material waste during manufacture of the first terminals 3, thereby lowering production cost of the plug connector 100.

In some embodiments, the plug inner housing 1 comprises two inner housing members 14 assembled together. In each inner housing member 14, there is a complete plug side wall 12, and a pair of end wall portions on opposite ends of the side wall 12 so as to bound half of the plug slot 13 together with the side wall 12. The main body 31 is insert molded in the plug side wall 12, whereby the first terminals 3 and the inner housing member 14 form an integral structure. Referring to FIGS. 1-5, the two inner housing members 14 are symmetrically arranged, with one end wall surrounding to form the plug slot 13. Two sets of first terminals 3 are symmetrically disposed within the two plug side walls 12. Because the two inner housing members 14 have the same or symmetrical shapes, the shaping difficulty during the production of the plug inner housing 1 and the first terminals 3 is reduced. Moreover, it has also multiplied the terminal density of the plug connector 100.

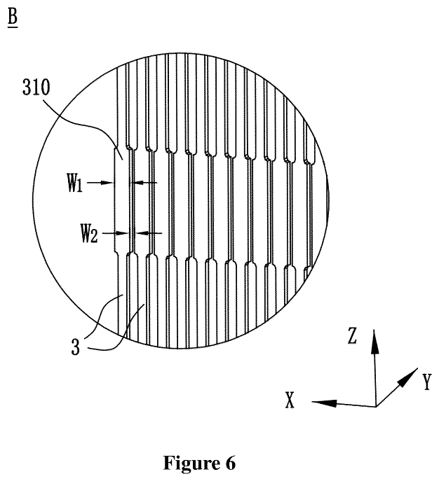

Referring to FIG. 6, in the horizontal direction X, the width of the fixing portion 310 is W1, and the distance between two adjacent first terminals 3 is W2, with the relationship: W1>W2 therebetween. Since the first terminal 3 and the plug inner housing 1 are fixed by insert molding and shaping, the shaping material of the plug inner housing 1 will be filled between adjacent first terminals 3. With the intervals of the shaping material of the plug inner housing 1, the mutual interference of electrical signals between adjacent first terminals 3 will be greatly reduced. Therefore, the spacing between two adjacent first terminals 3 can be set smaller than the width of the fixing portion 310 to improve the data transmission capability of the plug connector 100.

In some embodiments, the plug inner housing 1 can be disposed in the plug chamber 21 through a snapping structure. Structures such as board locks 22 and board lock receivers 23 can also be provided on both sides of the end of the plug outer housing 2 connected to the circuit board to achieve rapid connection between the plug connector 100 and the circuit board.

With the plug connector described herein, the main body is provided as a smooth linear structure and the first terminal is insert molded into the plug inner housing which enhances the manufacturing feasibility; and there is a more stable data transmission stability for high-frequency and high-speed inter-board data transmission compared to existing technical solutions.

Further, the first terminal does not require a dedicated mold. During mass production, the raw material length can be selected depending on practical needs to adapt to requirements of different board spacings. Under the premise of ensuring a firm connection between the first terminal and the plug inner housing, the utilization rate of the first terminal production line is improved, and the processing difficulty and the production cost for connectors of various lengths are reduced.

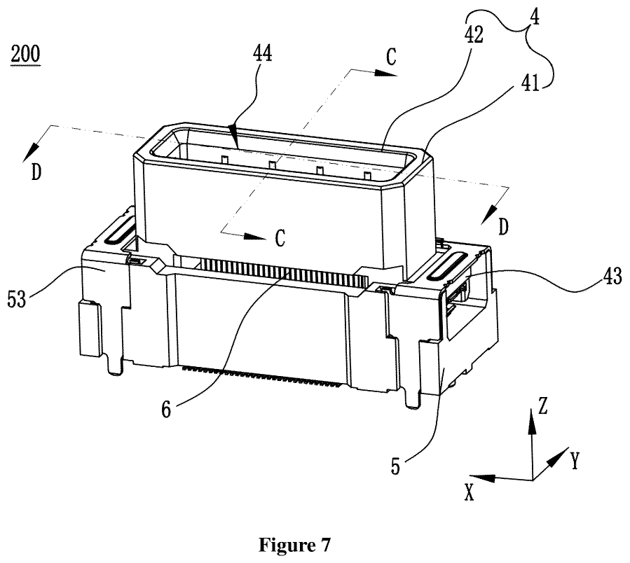

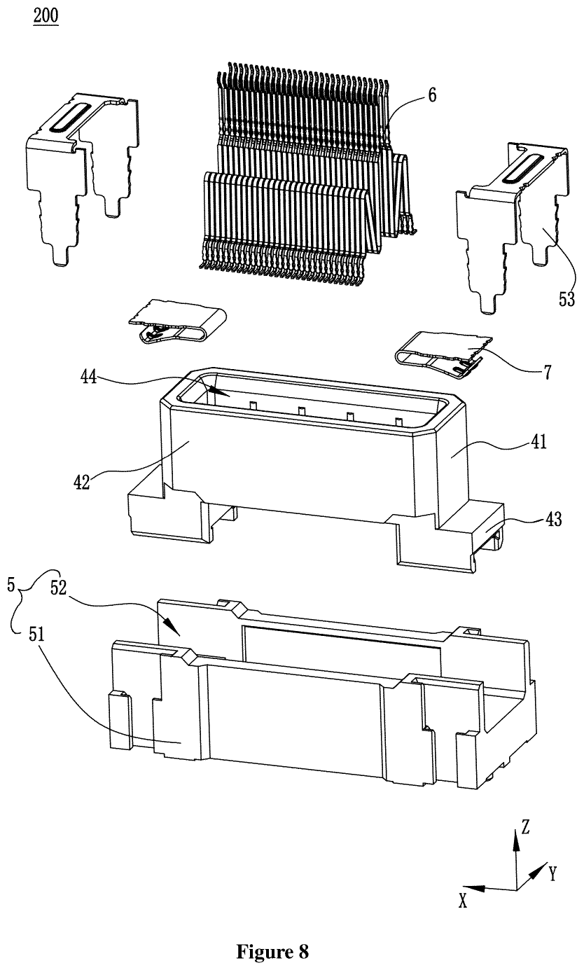

Referring to FIGS. 7-8, a receptacle connector 200, may include one end configured to mate with the plug connector 100, and the other end electrically configured to connect to a second circuit board, thereby achieving high-frequency and high-speed data transmission between boards. The receptacle connector 200 comprises a receptacle inner housing 4, a receptacle outer housing 5, and second terminals 6.

The receptacle outer housing 5 comprises a base 51 and a receptacle chamber 52 above the base 51. The receptacle inner housing 4 is disposed in the receptacle chamber 52 and protrudes above the receptacle chamber 52 in the mating direction Z. The receptacle inner housing 4 comprises a pair of receptacle end walls 41 separated in the horizontal direction X perpendicular to the mating direction Z, a pair of receptacle side walls 42 separated in the longitudinal direction Y perpendicular to both the mating direction Z and the horizontal direction X, and a pair of arms 43. The receptacle end walls 41 and the receptacle side walls 42 together surround to form a receptacle slot 44 elongated in the horizontal direction X. The pair of arms 43 of the receptacle inner housing 4 extend from lower ends of respective receptacle end walls 41 of the pair of receptacle end walls 41 in both the horizontal direction X and mating direction Z. The arms 43 are elastically connected to the base 51 such that the receptacle inner housing 4 is movable with respect to the receptacle outer housing 5 in the mating direction Z. Each second terminal 6 is an integrally shaped elastic metal member. Each of the plurality of second terminals 6 is elastically connected to both the receptacle inner housing 4 and the receptacle outer housing 5 such that contact portions of the plurality of second terminals 6 move with the receptacle inner housing 4 in the mating direction Z.

Through the elastic connection of the arms 43 to the base 51 and the provision of the elastic second terminals 6, an elastic floating structure is formed between the receptacle inner housing 4 and the receptacle outer housing 5. When the receptacle inner housing 4 bears a certain load in the mating direction Z and deforms, the connection between the receptacle inner housing 4 and the receptacle outer housing 5 can still be maintained stably, and the second terminals 6 will follow the deformation of the receptacle inner housing 4 and displace, achieving a stable electrical connection.

During implementation, to ensure that the arms 43 can be restricted on the base 51, locking members 53 are also disposed on the base 51 and configured to restrain movements of the arms 43 in the mating direction Z. The locking member 53 and the receptacle chamber 52 surround the arms 43, restricting the arms 43 in the receptacle chamber 52 and preventing the arms 43 from popping out of the receptacle chamber 52. In some embodiments, the end of the locking member 53 are configured to mount to a board to which the receptacle connector 200 is disposed on, thereby simplifying the receptacle connector 200.

Additionally, during static installation, there may be a certain deviation between the plug connector 100 and the receptacle connector 200, in particular in the mating direction Z. When there is a larger installation error between the two circuit boards, the receptacle inner housing 4 can also absorb the installation error between them to ensure reliable and stable connection.

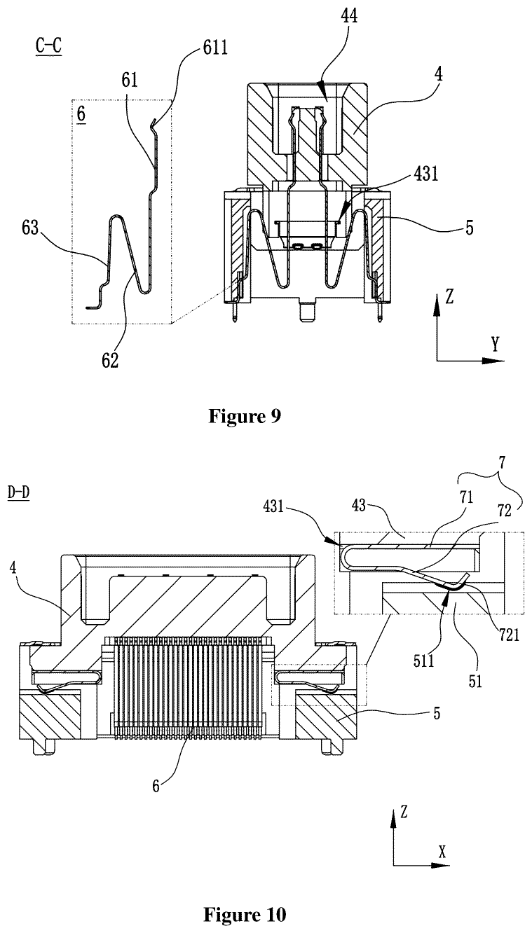

Referring to FIG. 9 in combination with FIGS. 7-8, each second terminal 6 comprises a first segment 61, a second segment 62, and a third segment 63 connected by bent portions. The first segment 61 is partially disposed in the receptacle inner housing 4, and partially disposed in the receptacle chamber 52. The second segment 62 is at least partially disposed in the receptacle chamber 52. The third segment 63 is at least partially disposed in the receptacle outer housing 5. The second terminal 6, through three segments formed by two bends, achieves the connection of the second terminal 6 to the receptacle inner housing 4 and the receptacle outer housing 5, respectively. As shown in FIG. 8, for the two second terminals 6 opposing and symmetrically arranged with respect to each other, their first segments 61 press and abut against the receptacle inner housing 4 and extend into the receptacle slot 44, ensuring that the first segments 61 can follow the movement of the receptacle inner housing 4 when there is an offset between the receptacle inner housing 4 and the receptacle outer housing 5. The third segment 63 abuts against and is at least partially fixed to the inner side of the receptacle outer housing 5, thereby ensuring secure connection between the second terminals 6 and the circuit board. The second segment 62 is movably arranged between the first segment 61 and the third segment 63. When deformation occurs, the bending positions at both ends of the second segment 62 absorb energy through deformation and drive the second segment 62 to displace, enabling the second terminals 6 to closely follow the movement of the receptacle inner housing 4, ensuring a stable electrical connection with respective first terminals 3.

In the illustrated example, the bent portions between the first segment 61 and the second segment 62, and between the second segment 62 and the third segment 63, comprise large-radius rounded corners. Large-radius rounded corners have improved energy absorption effects compared to small-radius rounded corners, and they are used to disperse stress during terminal floating, giving the second terminal 6 a larger deformation capacity, thereby satisfying the larger displacement generated by the receptacle inner housing 4. The bending amplitudes of adjacent segments comprise obtuse angles, further simplifying the elastic configuration of the second terminal 6. This ensures that the production cost of the second terminals 6 is lower under the condition of sufficient deformation.

In some embodiments, the receptacle inner housing 4 comprises a tongue 441 disposed in the receptacle slot 44. The first segment 61 comprises a second contact portion 611 that lines along the tongue 441 and curves into the receptacle slot 44. The second contact portion 611 is formed by first bending in a direction away from the receptacle slot 44 and then bending in a direction approaching the receptacle slot 44. The second contact portion 611 is configured to make contact with a respective first contact portion 32. The provision of the second contact portion 611 allows that during the connection process between the plug connector 100 and the receptacle connector 200, even if there is a certain tilt angle or local deformation between the first contact portion 32 and the second contact portion 611, the second contact portion 611 can still stably abut against the surface of the first contact portion 32, ensuring the reliability of the electrical connection.

As shown in FIG. 10, to further reduce production difficulty and reduce plastic wear during floating, the receptacle connector 200 further comprises a pair of U-shaped resilient members 7. Each of the pair of arms 43 of the receptacle inner housing 4 comprises a space 431 receiving a respective resilient member 7 of the pair of resilient members 7. Each resilient member 7 comprises a first portion 71 and a second portion 72 which are integrally shaped. The first portion 71 is fixedly disposed in the space 431 of a respective arm 43 of the pair of arms 43, of the receptacle inner housing 4, and the second portion 72 comprises a beam 721 movable with respect to the first portion 71 and abutting against the base 51. In the illustrated example, during production and assembling, the first portion 71 is inserted into the space 431 to complete fixation. The base 51 comprises a vertical gap 511 for abutting against and restricting the second portion 72. During installation, the beam 721 extends into the vertical gap 511 of the base 51 of the receptacle outer housing 5, thereby achieving the abutment and limitation between the second portion 72 and the base 51.

In some embodiments, the first portion 72 can also be fixed to the base 51, and the first portion 71 can abut against the arm 43, which can also achieve the floating connection effect between the receptacle inner housing 4 and the receptacle outer housing 5. The resilient member 7 is generally formed by bending an elastic metal sheet into an elastic U-shaped structure, which has excellent energy absorption effect.

It should be noted that the width of the fixing portion 310 is greater than the spacing width between adjacent first terminals 3 when the plug connector 100 is used. Correspondingly, the second terminal 6 in the receptacle connector 200 also has a corresponding dimensional relationship. For example, the width of the second terminal 6 is greater than the spacing width between adjacent second terminals 6, to ensure the consistency of electrical connection. Since there may be no corresponding insulating material for isolation provided between adjacent second terminals 6, attention should be paid to the spacing width between adjacent second terminals 6 to avoid problems such as signal interference during data transmission.

With the receptacle connector described herein, the independently arranged receptacle inner housing and receptacle outer housing are elastically connected to the base through the arms, and the second terminals are elastically arranged between the receptacle inner housing and the receptacle outer housing, and the receptacle connector can still ensure the effectiveness of the overall structure and the stability of the electrical connection within the allowable design range when there is a large deviation or offset between the receptacle inner housing and the receptacle outer housing in the mating direction.

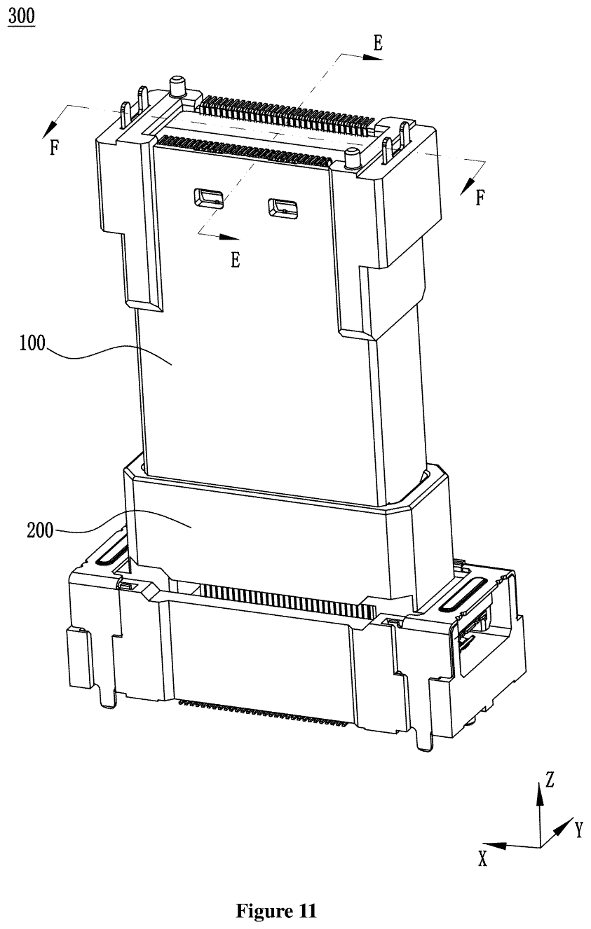

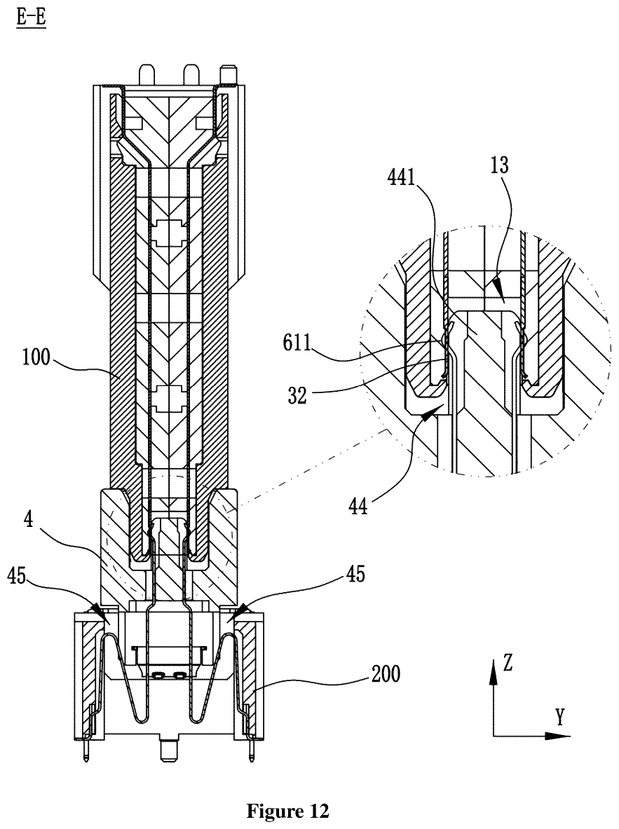

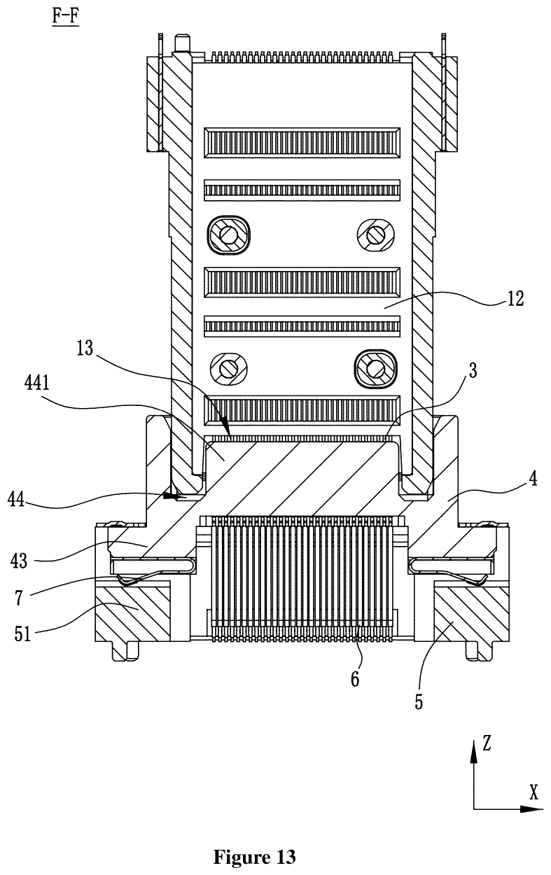

Referring to FIG. 11 in combination with FIGS. 1-10, a floating connector assembly 300 may comprise the plug connector 100 and the receptacle connector 200. The plug connector 100 is configured to mate with the receptacle connector 200 and is capable of driving the receptacle inner housing 4 to move in the mating direction Z such that boards connected to the receptacle connector 200 and the plug connector 100 are separated by a predetermined distance. As shown in FIG. 12 and FIG. 13, the tongue 441 is provided in the middle of the receptacle slot 44, and the second contact portion 611 is disposed around the periphery of the tongue 441. When the plug connector 100 is received in the receptacle slot 44 of the receptacle inner housing 4, one end of the plug connector 100 is inserted into the receptacle slot 44, and the tongue 441 extends into the plug slot 13. Thereby, the second contact portion 611 abuts against the first contact portion 32, achieving the electrical connection between the plug connector 100 and the receptacle connector 200.

When there is a certain offset in the mating direction Z between the plug connector 100 and the receptacle connector 200, or when positional offset occurs between the circuit boards connected to them, the plug connector 100 can move the receptacle inner housing 4 with respect to the receptacle outer housing 5 such that boards connected to the receptacle connector 200 and the plug connector 100 are separated by a predetermined distance. The plug connector 100 can drive the receptacle inner housing 4 to move downward relative to the receptacle outer housing 5 in the mating direction Z. In this case, the plug connector 100 and the receptacle inner housing 4 are in a relatively static state. The first contact portion 32 and the second contact portion 611 do not produce relative sliding, or the sliding distance is negligible, effectively reducing the wear of the coating at the contact position of the first terminal 3 and the second terminal 6, thereby improving the service life of the connector assembly. During high-frequency and high-speed data transmission, the reduced amount of displacement between the first contact portion 32 and the second contact portion 611 can improve the stability and effectiveness of the transmission process. Data transmission problems caused by positional floating between circuit boards, such as signal interference and signal loss, will be significantly suppressed.

Because the arms 43 are elastically connected to the base 51, the two ends of the elastic second terminal 6 are respectively disposed between the receptacle inner housing 4 and the receptacle outer housing 5. The eccentric load generated by the relatively stationary plug connector 100 and receptacle inner housing 4 is elastically absorbed, and the second terminal 6 follows after deformation, making the connection between the plug connector 100 and the receptacle connector 200 still effective. Moving the receptacle inner housing 4 with respect to the receptacle outer housing 5 may comprise expanding or compressing a resilient member 7 fixedly attached to an arm 43 of the receptacle inner housing 4. Moving the receptacle inner housing 4 with respect to the receptacle outer housing 5 may further comprise restraining movements of the arm 43 of the receptacle inner housing 4 with a locking member 53.

In some embodiments, a longitudinal gap 45 is also provided between the receptacle inner housing 4 and the receptacle outer housing 5 in the longitudinal direction Y. After the plug connector 100 is plugged with the receptacle inner housing 4, if subjected to an amount of offset from the longitudinal direction Y, the receptacle inner housing 4 can also produce a certain deformation in the longitudinal direction Y, absorbing the error and variable load generated in this direction.

With the floating connector assembly described herein, after the plug connector is plugged with the receptacle connector, because the receptacle inner housing and the receptacle outer housing form a floating connection, even if there is a large error value for the static connection position between the plug connector and the receptacle connector, or if relative displacement occurs between the circuit boards during equipment operation, the plug connector can still maintain a relatively static connection state with the receptacle inner housing, and the connection position between the first terminal and the second terminal remains basically unchanged, avoiding poor contact or unstable transmission, and improving the safety of data transmission and the service life.

Various aspects are described in this disclosure, which include, but are not limited to, the following aspects:

1. A receptacle connector (e.g., 200) comprising an outer housing (e.g., 5) comprising a base (e.g., 51) and a chamber (e.g., 52) above the base; an inner housing (e.g., 4) disposed in the chamber and protruding above the chamber in a mating direction (e.g., Z), the inner housing comprising a pair of arms (e.g., 43) elastically connected to the base of the outer housing such that the inner housing is movable with respect to the outer housing in the mating direction; and a plurality of terminals (e.g., 6) elastically connected to both the inner housing and the outer housing such that contact portions (e.g., 611) of the plurality of terminals move with the inner housing in the mating direction.

2.The receptacle connector of aspect 1 or any other aspect, wherein the inner housing (e.g., 4) comprises a pair of end walls (e.g., 41) separated in a horizontal direction (e.g., X) perpendicular to the mating direction, a pair of side walls (e.g., 42) separated in a longitudinal direction (e.g., Y) perpendicular to both the mating direction and the horizontal direction, and a slot (e.g., 44) bounded by the pair of end walls and the pair of side walls; and the pair of arms (e.g., 43) of the inner housing extend from lower ends of respective end walls of the pair of end walls in both the horizontal direction and mating direction.

3. The receptacle connector of aspect 2 or any other aspect, wherein the slot (e.g., 44) is elongated in the horizontal direction (e.g., X).

4. The receptacle connector of aspect 2 or aspect 3 or any other aspect, comprising a pair of resilient members (e.g., 7); wherein each of the pair of arms (e.g., 43) of the inner housing comprises a space (e.g., 431) receiving a respective resilient member of the pair of resilient members.

5. The receptacle connector of aspect 4 or any other aspect, wherein each of the pair of resilient members (e.g., 7) comprises a first portion (e.g., 71) fixedly disposed in the space of a respective arm of the pair of arms of the inner housing, and a second portion (e.g., 72) comprising a beam (e.g., 721) movable with respect to the first portion.

6. The receptacle connector of aspect 5 or any other aspect, wherein the base (e.g., 51) of the outer housing comprises a gap (e.g., 511); and the beam (e.g., 721) extends into the gap of the base of the outer housing.

7. The receptacle connector of any of aspects 2-6 or any other aspect, wherein each of the plurality of terminals (e.g., 6) comprises a first segment (e.g., 61) partially disposed in the inner housing, a second segment (e.g., 62) at least partially disposed in the chamber of the outer housing, and a third segment (e.g., 63) at least partially disposed in the outer housing; and for each of the plurality of terminals, the first segment, second segment, and third segment are connected by respective bent portions.

8. The receptacle connector of aspect 7 or any other aspect, wherein the inner housing (e.g., 4) comprises a tongue (e.g., 441) disposed in the slot; and the first segment (e.g., 61) of each of the plurality of terminals comprises a contact portion (e.g., 611) that lines along the tongue and curves into the slot.

9. The receptacle connector of any of aspects 1-8 or any other aspect, comprising a pair of locking members (e.g., 53) disposed on the base and configured to restrain movements of the pair of arms in the mating direction.

10. The receptacle connector of aspect 9 or any other aspect, wherein the pair of locking members (e.g., 53) are configured to mount to a board to which the receptacle connector is disposed on.

11. A floating connector assembly (e.g., 300) comprising the receptacle connector of any of aspects 1-10 or any other aspect; and a plug connector (e.g., 100) configured to mate with the receptacle connector and capable of driving the inner housing to move in the mating direction such that boards connected to the receptacle connector and the plug connector are separated by a predetermined distance.

12. A method of operating a receptacle connector (e.g., 200) comprising an outer housing (e.g., 5) having a chamber (e.g., 52), and an inner housing (e.g., 4) disposed in the chamber and protruding above the chamber, the inner housing having a slot (e.g., 44), the method comprising receiving a plug connector (e.g., 100) in the slot of the inner housing; and moving the inner housing with respect to the outer housing by the plug connector such that boards connected to the receptacle connector and the plug connector are separated by a predetermined distance.

13. The method of aspect 12 or any other aspect, wherein moving the inner housing with respect to the outer housing comprises expanding or compressing a resilient member (e.g., 7) fixedly attached to an arm (e.g., 43) of the inner housing.

14. The method of aspect 13 or any other aspect, wherein moving the inner housing with respect to the outer housing comprises restraining movements of the arm (e.g., 43) of the inner housing with a locking member (e.g., 53).

15. A plug connector (e.g., 100) comprising an outer housing (e.g., 2) comprising a chamber (e.g., 21); and a pair of subassemblies at least partially separated by a slot (e.g., 13) therebetween, each subassembly comprising an inner housing member (e.g., 14) disposed in the chamber of the outer housing, and a plurality of terminals (e.g., 3) held by the inner housing member, each of the plurality of terminals comprising a contact portion (e.g., 32) accessible through the slot, a contact tail (e.g., 33) extending out of the outer housing, and a main body (e.g., 31) between the contact portion and the contact tail.

16. The plug connector of aspect 15 or any other aspect, wherein, for each of the pair of subassemblies, the inner housing member (e.g., 14) comprises a side wall (e.g., 12), and a pair of end wall portions on opposite ends of the side wall so as to bound half of the slot together with the side wall.

17. The plug connector of aspect 16 or any other aspect, wherein the side wall (e.g., 12) comprises a plurality of mounting channel portions (e.g., 121); and the contact tails (e.g., 33) of the plurality of terminals of the subassembly are partially disposed in respective mounting channel portions of the plurality of mounting channel portions.

18. The plug connector of any of aspects 16-17 or any other aspect, wherein, for each of the plurality of terminals (e.g., 3), the main body (e.g., 31) elongates in a mating direction (e.g., Z), and has a constant thickness in a longitudinal direction (e.g., Y) perpendicular to the mating direction.

19. The plug connector of aspect 18 or any other aspect, wherein the main body (e.g., 31) comprises a fixing portion (e.g., 310) extending in a horizontal direction (e.g., X) perpendicular to both the mating direction and the longitudinal direction.

20. The plug connector of aspect 19 or any other aspect, wherein the side wall (e.g., 12) comprises a plurality of channel portions (e.g., 122) in a hollow region; and the fixing portions (e.g., 310) are disposed corresponding to the plurality of channel portions.

21. A plug connector (e.g., 100) comprising a plug inner housing (e.g., 1) comprising a pair of plug end walls (e.g., 11) separated in a horizontal direction (e.g., X) and a pair of plug side walls (e.g., 12) separated in a longitudinal direction (e.g., Y), the plug end walls and the plug side walls together surrounding a plug slot (e.g., 13), each plug side wall comprising a plurality of mounting channel portions (e.g., 121); a plug outer housing (e.g., 2) comprising a plug chamber (e.g., 21), the plug inner housing disposed in the plug chamber; and a plurality of first terminals (e.g., 3) insert molded in the plug inner housing, each first terminal comprising a main body (e.g., 31) and a first contact portion (e.g., 32) and a contact tail (e.g., 33) at opposite ends of the main body, the contact tail bending from a lower end of the main body in a direction away from the plug slot, and the contact tail embedded in the mounting channel portion, wherein the main body is a smooth linear structure in a mating direction (e.g., Z).

22. The plug connector of aspect 21 or any other aspect, wherein, for each of the plurality of first terminals (e.g., 3), the main body (e.g., 31) extends along the mating direction (e.g., Z) and has a constant width in the horizontal direction (e.g., X) and a constant thickness in the longitudinal direction (e.g., Y).

23. The plug connector of aspect 21 or any other aspect, wherein, for each of the plurality of first terminals (e.g., 3), the main body (e.g., 31) extends along the mating direction (e.g., Z) and comprises a fixing portion (e.g., 310) that is thickened in the horizontal direction (e.g., X); the plug side wall (e.g., 12) comprises a plurality of channel portions (e.g., 122) in a hollow region; and the fixing portions are disposed corresponding to the channel portions.

24. The plug connector of aspect 23 or any other aspect, wherein the fixing portion (e.g., 310) comprises a first fixing block (e.g., 311) and a second fixing block (e.g., 312); in the horizontal direction (e.g., X), a width of the first fixing block is the same as a width of the second fixing block; in the longitudinal direction (e.g., Y), a thickness of the first fixing block is the same as a thickness of the second fixing block; and in the mating direction (e.g., Z), a height of the first fixing block is the same as or different from a height of the second fixing block, and the first fixing block and the second fixing block are alternately disposed on the main body (e.g., 31).

25. The plug connector of aspect 24 or any other aspect, wherein neither the first fixing block (e.g., 311) nor the second fixing block (e.g., 312) comprises a barb or hook extending in the horizontal direction (e.g., X).

26. The plug connector of aspect 21 or any other aspect, wherein the plug inner housing (e.g., 1) comprises a pair of inner housing members (e.g., 14) assembled together; each inner housing member comprises one of the pair of plug side walls (e.g., 12); the main bodies (e.g., 31) are insert molded in the plug side wall, whereby the first terminal (e.g., 3) and the inner housing member form an integral structure.

27. A receptacle connector (e.g., 200) configured to mate with the plug connector of any of aspects 21-26 or any other aspect, the receptacle connector comprising a receptacle inner housing (e.g., 4) comprising a pair of receptacle end walls (e.g., 41) separated in the horizontal direction (e.g., X), a pair of receptacle side walls (e.g., 42) separated in the longitudinal direction (e.g., Y), and a pair of arms (e.g., 43), the receptacle end walls and the receptacle side walls together surrounding a receptacle slot (e.g., 44), the arms extending from lower ends of the receptacle end walls in both the horizontal direction and mating direction (e.g., Z); a receptacle outer housing (e.g., 5) comprising a base (e.g., 51) and a receptacle chamber (e.g., 52) above the base, the receptacle inner housing disposed in the receptacle chamber, and the arms elastically connected to the base; and a plurality of second terminals (e.g., 6), each an integrally shaped elastic metal member and connected to both the receptacle inner housing and the receptacle outer housing.

28. The receptacle connector of aspect 27 or any other aspect, wherein each second terminal (e.g., 6) comprises a first segment (e.g., 61), a second segment (e.g., 62), and a third segment (e.g., 63), the first segment partially disposed in the receptacle inner housing (e.g., 4) and partially disposed in the receptacle chamber (e.g., 52), the second segment at least partially disposed in the receptacle chamber, the third segment at least partially disposed in the receptacle outer housing (e.g., 5).

29. The receptacle connector of aspect 28 or any other aspect, wherein, for each second terminal (e.g., 6), the first segment (e.g., 61) comprises a second contact portion (e.g., 611); the second contact portion first bends in a direction away from the receptacle slot (e.g., 44) and then bends in a direction approaching the receptacle slot; and the second contact portion is configured to make contact with a respective first contact portion (e.g., 32).

30. The receptacle connector of aspect 27 or any other aspect, comprising a U-shaped resilient member (e.g., 7), the resilient member comprising a first portion (e.g., 71) and a second portion (e.g., 72) integrally shaped, the first portion fixed to a bottom of the arm (e.g., 43), and the second portion abutting against the base (e.g., 51).

31. A floating connector assembly (e.g., 300) comprising the plug connector (e.g., 100) of any of aspects 21-26 or any other aspect; and the receptacle connector (e.g., 200) of any of aspects 27-30 or any other aspect, wherein the plug connector is mated with the receptacle connector; and the plug connector is capable of driving the receptacle inner housing (e.g., 4) to move downward relative to the receptacle outer housing (e.g., 5) in the mating direction (e.g., Z).

Having thus described several aspects of several embodiments, it is to be appreciated that various alterations, modifications, and improvements will readily occur to those skilled in the art. Such alterations, modifications, and improvements are intended to be part of this disclosure and are intended to be within the spirit and scope of the invention. While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art.

As an example, although many creative aspects have been described above with reference to vertical connectors, it should be understood that the aspects of the present disclosure are not limited to these. Any one of the creative features, whether alone or combined with one or more other creative features, can also be used for other types of electrical connectors, such as right angle connectors, etc.

Further, though some advantages of the present invention may be indicated, it should be appreciated that not every embodiment of the invention will include every described advantage. Some embodiments may not implement any features described as advantageous. Accordingly, the foregoing description and drawings are by way of example only.

Also, the technology described may be embodied as a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used, should be understood to control over dictionary definitions, definitions in documents incorporated by reference, and/or ordinary meanings of the defined terms.

In the description of the present disclosure, it is to be understood that orientation or positional relationships indicated by orientation words “front”, “rear,” “upper,” “lower,” “left,” “right,” “transverse direction,” “vertical direction,” “perpendicular,” “horizontal,” “top,” “bottom” and the like are shown based on the accompanying drawings, for the purposes of the ease in describing the present disclosure and simplification of its descriptions. Unless stated to the contrary, these orientation words do not indicate or imply that the specified apparatus or element has to be specifically located, and structured and operated in a specific direction, and therefore, should not be understood as limitations to the present disclosure. The orientation words “inside” and “outside” refer to the inside and outside relative to the contour of each component itself.

For facilitating description, the spatial relative terms such as “on,” “above,” “on an upper surface of ” and “upper” may be used here to describe a spatial position relationship between one or more components or features and other components or features shown in the accompanying drawings. It should be understood that the spatial relative terms not only include the orientations of the components shown in the accompanying drawings, but also include different orientations in use or operation. For example, if the component in the accompanying drawings is turned upside down completely, the component “above other components or features” or “on other components or features” will include the case where the component is “below other components or features” or “under other components or features.” Thus, the exemplary term “above” can encompass both the orientations of “above” and “below.” In addition, these components or features may be otherwise oriented (for example rotated by 90 degrees or other angles) and the present disclosure is intended to include all these cases.

It should be noted that when an element is referred to as being “fixed to” another element, it can be directly on the other element or there may be an intervening element. When an element is considered to be “connected” to another element, it can be directly connected to the other element or there may be an intervening element simultaneously.

It should be noted that the terms used herein are for describing specific embodiments, and are not intended to limit the exemplary embodiments according to the present application. As used herein, an expression of a singular form includes an expression of a plural form unless otherwise indicated. In addition, it should also be understood that when the terms “including” and/or “comprising” are used herein, it indicates the presence of features, steps, operations, parts, components and/or combinations thereof.

The indefinite articles “a” and “an,” as used in the specification and in the claims, unless clearly indicated to the contrary, should be understood to mean “at least one.”

The phrase “and/or,” as used in the specification and in the claims, should be understood to mean “either or both” of the elements so conjoined, e.g., elements that are conjunctively present in some cases and disjunctively present in other cases. Multiple elements listed with “and/or” should be construed in the same fashion, e.g., “one or more” of the elements so conjoined. Other elements may optionally be present other than the elements specifically identified by the “and/or” clause, whether related or unrelated to those elements specifically identified. Thus, as a non-limiting example, a reference to “A and/or B,” when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, e.g., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also enables that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally Including other elements); etc.

In the claims, as well as in the specification above, all transitional phrases such as “comprising,” “including,” “carrying,” “having,” “containing,” “involving,” “holding,” “composed of,” and the like are to be understood to be open-ended, e.g., to mean including but not limited to. For example, a process, method, system, product or device that contains a series of steps or units need not be limited to those steps or units that are clearly listed, instead, it may include other steps or units that are not clearly listed or are inherent to these processes, methods, products or devices. Only the transitional phrases “consisting of” and “consisting essentially of” shall be closed or semi-closed transitional phrases, respectively.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

In the claims, as well as in the specification above, use of ordinal terms such as “first,” “second,” “third,” etc. does not by itself connote any priority, precedence, or order of one element over another or the temporal order in which acts of a method are performed, but are used merely as labels to distinguish one element having a certain name from another element having a same name (but for use of the ordinal term) to distinguish the elements.

The above content merely illustrates and describes the structure of the present disclosure with examples, and the description is relatively specific and detailed, but it should not therefore be understood as limiting the patent scope of the present disclosure. It should be pointed out that for those of ordinary skill in the art, without departing from the concept of the present disclosure, several modifications and improvements can be made, and these obvious alternative forms fall within the scope of the present disclosure.

What is claimed is:

1. A receptacle connector comprising:
an outer housing comprising a base and a chamber above the base;
an inner housing disposed in the chamber and protruding above the chamber in a mating direction, the inner housing comprising a pair of arms elastically connected to the base of the outer housing such that the inner housing is movable with respect to the outer housing in the mating direction; and
a plurality of terminals elastically connected to both the inner housing and the outer housing such that contact portions of the plurality of terminals move with the inner housing in the mating direction.

2. The receptacle connector of claim 1, wherein:
the inner housing comprises a pair of end walls separated in a horizontal direction perpendicular to the mating direction, a pair of side walls separated in a longitudinal direction perpendicular to both the mating direction and the horizontal direction, and a slot bounded by the pair of end walls and the pair of side walls; and
the pair of arms of the inner housing extend from lower ends of respective end walls of the pair of end walls in both the horizontal direction and mating direction.

3. The receptacle connector of claim 2, wherein:
the slot is elongated in the horizontal direction.

4. The receptacle connector of claim 2, comprising:
a pair of resilient members;
wherein each of the pair of arms of the inner housing comprises a space receiving a respective resilient member of the pair of resilient members.

5. The receptacle connector of claim 4, wherein:
each of the pair of resilient members comprises a first portion fixedly disposed in the space of a respective arm of the pair of arms of the inner housing, and a second portion comprising a beam movable with respect to the first portion.

6. The receptacle connector of claim 5, wherein:
the base of the outer housing comprises a gap; and
the beam extends into the gap of the base of the outer housing.

7. The receptacle connector of claim 2, wherein:
each of the plurality of terminals comprises a first segment partially disposed in the inner housing, a second segment at least partially disposed in the chamber of the outer housing, and a third segment at least partially disposed in the outer housing; and
for each of the plurality of terminals, the first segment, second segment, and third segment are connected by respective bent portions.

8. The receptacle connector of claim 7, wherein:
the inner housing comprises a tongue disposed in the slot; and
the first segment of each of the plurality of terminals comprises a contact portion lines along the tongue and curves into the slot.

9. The receptacle connector of claim 1, comprising:
a pair of locking members disposed on the base and configured to restrain movements of the pair of arms in the mating direction.

10. The receptacle connector of claim 9, wherein:
the pair of locking members are configured to mount to a board to which the receptacle connector is disposed on.

11. A floating connector assembly comprising:
the receptacle connector of claim 1; and
a plug connector configured to mate with the receptacle connector and capable of driving the inner housing to move in the mating direction such that boards connected to the receptacle connector and the plug connector are separated by a predetermined distance.

12. A method of operating a receptacle connector comprising an outer housing having a chamber, and an inner housing disposed in the chamber and protruding above the chamber, the inner housing having a slot, the method comprising:
receiving a plug connector in the slot of the inner housing; and
moving the inner housing with respect to the outer housing by the plug connector such that boards connected to the receptacle connector and the plug connector are separated by a predetermined distance.

13. The method of claim 12, wherein moving the inner housing with respect to the outer housing comprises:
expanding or compressing a resilient member fixedly attached to an arm of the inner housing.

14. The method of claim 13, wherein moving the inner housing with respect to the outer housing comprises:
restraining movements of the arm of the inner housing with a locking member.

15. A plug connector comprising:
an outer housing comprising a chamber; and
a pair of subassemblies at least partially separated by a slot therebetween, each subassembly comprising an inner housing member disposed in the chamber of the outer housing, and a plurality of terminals held by the inner housing member, each of the plurality of terminals comprising a contact portion accessible through the slot, a contact tail extending out of the outer housing, and a main body between the contact portion and the contact tail.

16. The plug connector of claim 15, wherein, for each of the pair of subassemblies:
the inner housing member comprises a side wall, and a pair of end wall portions on opposite ends of the side wall so as to bound half of the slot together with the side wall.

17. The plug connector of claim 16, wherein:
the side wall comprises a plurality of mounting channel portions; and
the contact tails of the plurality of terminals of the subassembly are partially disposed in respective mounting channel portions of the plurality of mounting channel portions.

18. The plug connector of claim 16, wherein, for each of the plurality of terminals:
the main body elongates in a mating direction, and has a constant thickness in a longitudinal direction perpendicular to the mating direction.

19. The plug connector of claim 18, wherein:
the main body comprises a fixing portion extending in a horizontal direction perpendicular to both the mating direction and the longitudinal direction.

20. The plug connector of claim 19, wherein:
the side wall comprises a plurality of channel portions in a hollow region; and
the fixing portions are disposed corresponding to the plurality of channel portions.
